(19) United States
(12) Patent Application Publication
(10) Pub. No.: US 2025/0229275 A1
(43) Pub. Date: Jul. 17, 2025

(54) APPARATUS AND METHOD FOR SEPARATING MATERIALS USING STRATIFICATION

(71) Applicant: Thomas A. Valerio, Atlanta, GA (US)

(72) Inventor: Thomas A. Valerio, Atlanta, GA (US)

(21) Appl. No.: 19/061,095

(22) Filed: Feb. 24, 2025

Related U.S. Application Data
(63) Continuation of application No. 16/465,522, filed on May 30, 2019.
Application No. 16/465,522 is a continuation of application No. PCT/US2017/064082, filed on Nov. 30, 2017.
(60) Provisional application No. 62/428,520, filed on Nov. 30, 2016.

(51) Int. Cl. B03B 5/38; B03B 5/62; B03B 13/00

(52) U.S. Cl. CPC B03B 5/38; B03B 5/623; B03B 13/00

(57) ABSTRACT

A system for separating materials from a waste stream includes multiple processing units arranged linearly, each configured to employ a density separation process. The system incorporates a paddlewheel or similar agitator in one or more of the units, thereby providing enhanced control over the agitation and forces used to separate heavier fractions from lighter fractions. By adjusting paddlewheel speed and other operational parameters, residence times in each unit can be optimized to maximize overall separation efficiency.

### CROSS-REFERENCE TO RELATED APPLICATIONS

This application is a continuation of U.S. patent application Ser. No. 16/465,522, filed May 30, 2019, which is a national stage application, filed under 35 U.S.C. § 371, of International Patent Application No. PCT/US2017/064082, which claims the benefit of U.S. Provisional Patent Application No. 62/428,520, filed Jul. 1, 2016, each of which is incorporated by reference herein in its entirety.

### TECHNICAL FIELD

This application relates to an apparatus for sorting materials. More specifically, this application relates to an apparatus that employs a paddlewheel or the like inside a multiunit module or linear system that allows water to pass through in order to sort and recover materials from waste materials.

### BACKGROUND

Recycling of waste materials is highly desirable from many viewpoints, not the least of which are financial and ecological. Properly sorted recyclable materials often can be sold for significant revenue. Many of the more valuable recyclable materials do not biodegrade within a short period. Therefore, recycling such materials significantly reduces the strain on local landfills and ultimately the environment.

Typically, waste streams are composed of a variety of types of waste materials.

One such waste stream is generated from the recovery and recycling of automobiles or other large machinery and appliances. For example, at the end of its useful life, an automobile will be shredded. This shredded material can be processed to recover ferrous metals. The remaining materials, referred to as automobile shredder residue (ASR) typically would be disposed in a landfill. Recently, efforts have been made to recover additional materials from ASR, such as plastics and non-ferrous metals. Similar efforts have been made to recover materials from whitegood shredder residue (WSR), which are the waste materials left over after recovering ferrous metals from shredded machinery or large appliances. Other waste streams may include electronic components, building components, retrieved landfill material, incinerator ash which can be bottom ash or combined ash, and other industrial waste streams. These materials generally are of value only when they have been separated into like-type materials. However, in many instances, cost-effective methods are not available to effectively sort waste streams that contain diverse materials. This deficiency has been particularly true for non-ferrous materials.

This combination of diverse materials and diverse material sizes, densities, shapes and moisture content provide a unique challenge in separating and recycling specific materials in an efficient manner. The ability to efficiently separate and concentrate recyclable materials at high throughputs from the different waste streams reduces the negative environmental impact of these materials, as less of this residue will be disposed of in landfills.

### SUMMARY

This disclosure generally provides a system for separating materials in a waste stream. The system includes a feeder or an infeed conveyor and one or more sorting units. Each of the one or more sorting unit comprises a processing container, an inlet, an outlet, a paddlewheel, an axial connection, and a discharge device configured to allow discharge of a stratified waste material. A processing media is also included within the processing container and the processing media comprises a given specific gravity. The paddlewheel is configured to rotate in a manner that generates an agitation of the processing media within the sorting unit. The axial connection is configured to generate a vertical motion of the processing media within the sorting unit. The infeed conveyor is configured to introduce the waste stream into the inlet of a first sorting unit. In operation, the agitation and vertical motion of the processing media is configured to separate the waste stream into at least a light portion and a heavy portion within each of the one or more sorting units. The discharge device of the first sorting unit is configured to receive and discharge the heavy portion from the processing container of the first sorting unit. The outlet of the first sorting unit is configured to receive the light portion from the processing container of the first sorting unit.

Also disclosed is a method of separating materials in a waste stream using the sorting apparatus described above.

These and other features of the embodiments disclosed herein will become more fully apparent from the following description and appended claims.

### BRIEF DESCRIPTION OF DRAWINGS

FIG. 1 is a schematic view of the density separator according to the present disclosure having multiple units.

FIG. 2 is a perspective view of another embodiment showing three more units.

FIG. 3 is a process flow diagram illustrating a method for separating materials in a waste stream in three-unit embodiment in accordance with the present disclosure.

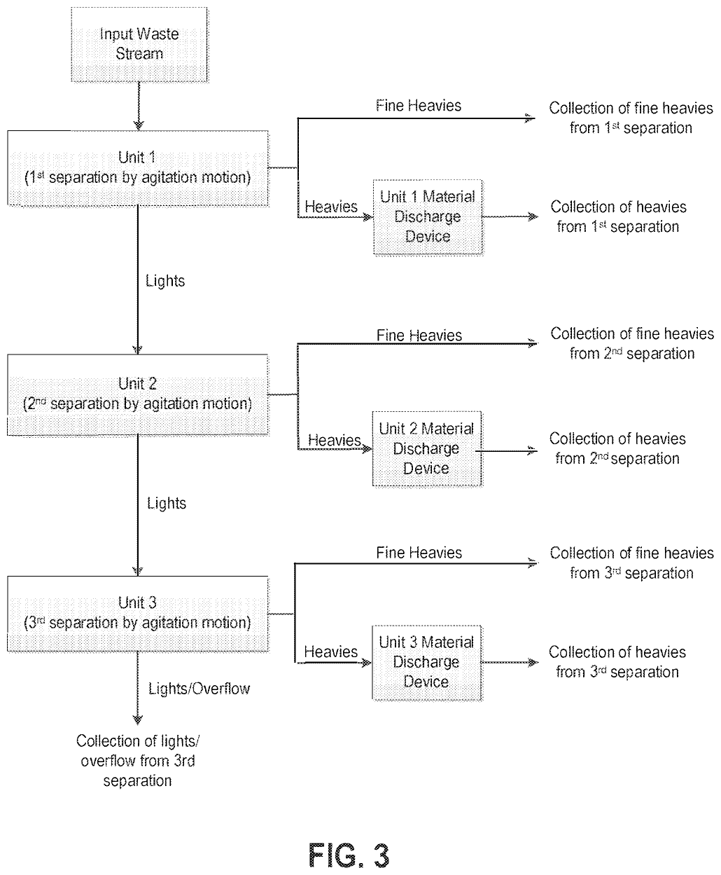

FIG. 4 is a perspective side view of a density separator with multiple units and the associated feeder conveyor.

FIG. 5 provides a top view of the density separator and feed conveyor of FIG. 4.

FIG. 6 provides a side view of the density separator and feed conveyor of FIG. 4 and the paddlewheels have been removed from each of the three units.

### DETAILED DESCRIPTION

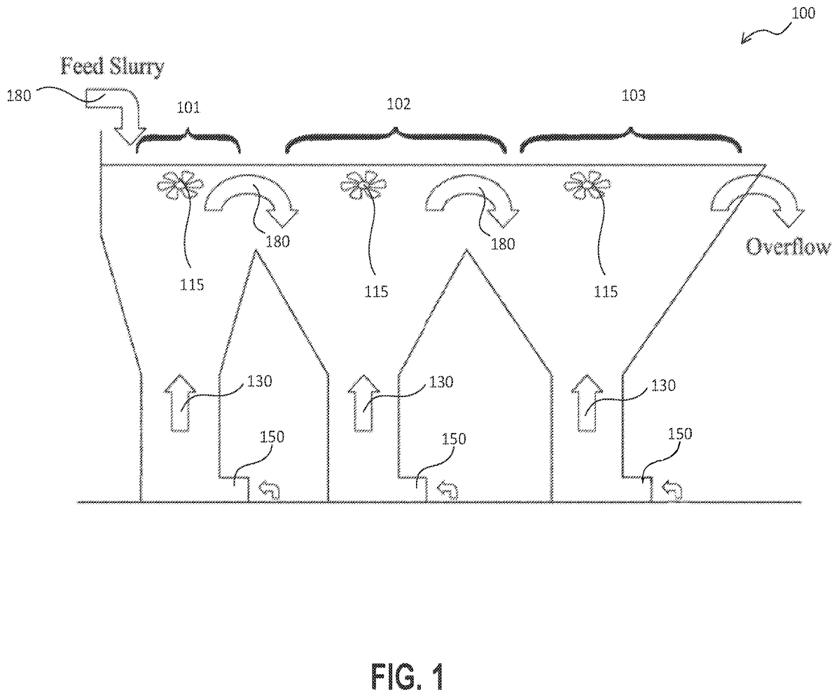

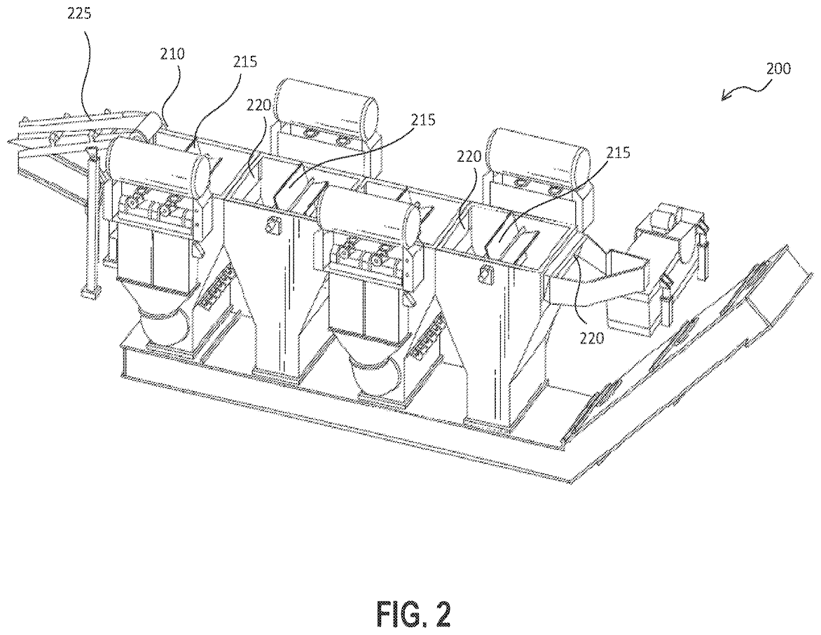

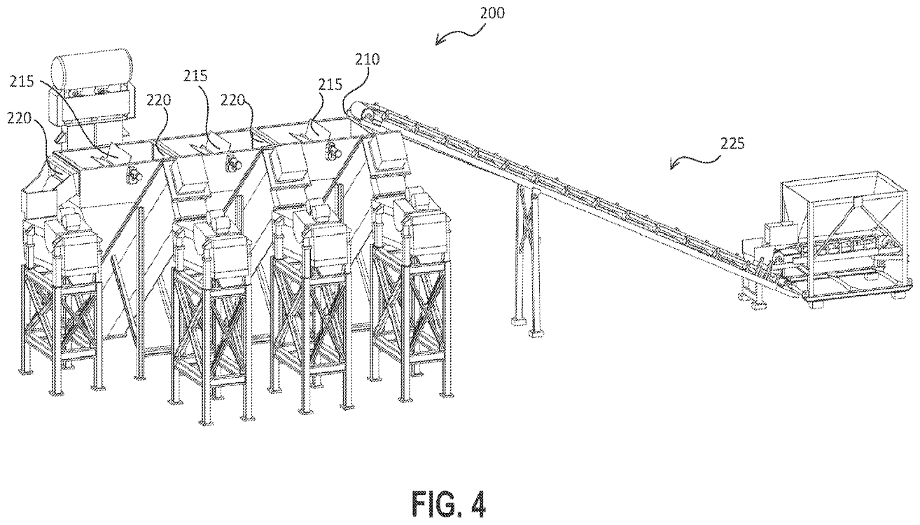

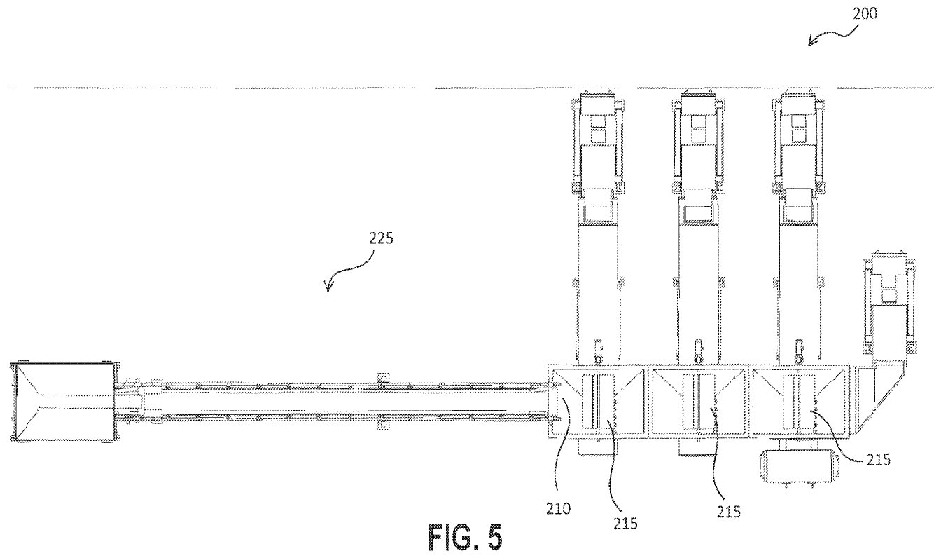

In general, this disclosure includes methods and systems for separating materials in a waste stream 180. The present disclosure presents a sorting apparatus with the use of up/down (or vertical) motion flow of water or other media, which can be thought of as a cascaded density separator. A sorting apparatus may include, e.g., a multiunit system 100, 200, together referred to as a linear system. The multiunit system has units that are one or more rectangular or conical units in a linear arrangement. See, e.g., FIGS. 1-2 and FIGS. 4-6. In one example, the multiunit system includes a rectangular housing having an interior surface, an inlet 210 and an outlet 220. In one embodiment, a waste stream 180 is introduced into the inlet 210 of a first separator unit 101, 201 via an infeed conveyor 225. Water or other media can fill each or all of the units to a predetermined level. Each of the units, e.g., at or near the top of the multiunit system, can have a mixer or a paddlewheel 115, 215 or similar component (capable of moving water) that may be powered (or unpowered) to agitate the water in an up/down motion. When the water hits the rotating paddlewheel 115, 215, the energy of the paddlewheel 115, 215 is transferred to the water, forcing the water out to move or pulse. The water is displaced outward, and more water can now enter the suction side of the pump to replace the displaced water. Materials to be sorted can enter the unit through a feed chute/inlet 210 located, e.g., on the top of the unit next to or above the paddlewheel 115, 215.

In one example, the paddlewheel 115, 215 comprises a shaft that extends from the center-top portion of the unit down towards the middle cone. On the bottom of the shaft, fixed paddles are provided. In operation, the paddlewheel 115, 215 rotates to generate an agitation of the water. The motion generated by the paddlewheel 115, 215 can be controlled motion, e.g., through control of the paddlewheel 115, 215. In contrast to a quiet/stable bath, the paddlewheel 115, 215 and other elements can provide an active bath with a motion and shear forces in each of the units.

The stratification from the vertical motion or up/down motion is generated through an axial connection 150. Such connection allows for water or other media 130 to be entered into the unit. Such water or media that enters through the axial connection generates an upward and downward motion 130, therefore the third-dimension of the separation apparatus. The axial connection 150 may also be tangential and in the form of a chamber. One example of the stratification apparatus can be an air-over-water pulsating chamber. In such an example, air inside a chamber expands and contracts creating an upward and downward flow of water into the unit through the axial or tangential connection.

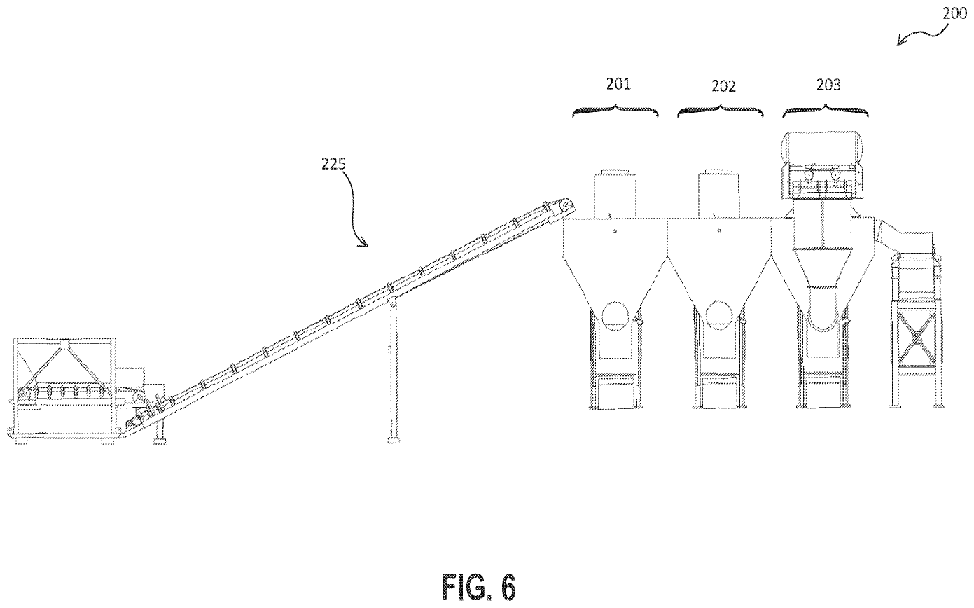

In one embodiment, as shown in FIGS. 1 and 6, the apparatus includes multiple rectangular/box-shaped units to provide more control over the agitation and forces separating the material. More specifically, in this arrangement, the slurry or waste stream 180 is fed into the first unit 101, 201, and from the first unit, the slurry or waste stream 180 flows into the second unit 102, 202, and from the second unit the slurry or waste stream 180 flows into the third unit 103, 303, and so forth. The paddlewheel 115, 215 in some or all of the units creates agitation, a shear force, and an upward/rising current 130.

Further, sensors, whether in the units or outside thereof, can be operatively linked to the paddlewheel 115, 215 to maintain a desired agitation state within the units. The frequency and the amplitude of the forces/waves in the units can be set to optimize separation efficiencies. These parameters can be used to control the residence time of particles.

In another embodiment, each unit can be set to create a separation based on a specific gravity separation that may be preset or dynamic. For example, one unit could separate using multiple parameters—that one or more of the units may have water with a rising current at 1.0 SG and another could use 1.6 SG. Each unit can have its own and separate specific gravity separation.

The agitation motion and shear forces allow for materials to move inside the units. The resulting action causes heavier particles to be liberated from the lighter particles. The heavier recyclables that sink to the bottom are discharged at the bottom of the unit with the use of a discharge device such as a movable gate or rotary valve or any other device to move the heavier particles or that prevent the continuous discharge of water but allows the heavier recyclables to exit when the device is energized. The lighter materials stay in suspension on the top of the unit are eventually discharged continuously by the carrying circular current through a tangential passage located on the high side of the unit.

The rotational speed of the paddlewheel 115, 215 as well as the frequency and stroke of the stratification apparatus of the unit may be varied to optimize the separation process. Without intending to be bound to specific theory, these two effects are combined into a single separation unit in which several principles come into play such as the Archimedes Principle, which explains how the apparent weight of an object immersed in water decreases. Other principles applied due to the density separation includes the Hindered Settling effect, the Consolidation Trickling effect, as well as the Jerk Effect also referred to as the Jolt Surge effect that is caused by both the motion created by the paddlewheel 115, 215 and the upward/downward movement of the stratification component. The paddlewheel need not be in each and every unit.

The upward and/or downward motion of the water or media enhances the separation by reducing the amount of lighter materials that are misplaced or entangled with heavier materials that sink to the bottom of the density separator. Such upward and downward motion 130, referred to as the third separation dimension, can be provided through the axial or tangential pipe 150 or chamber in the form of pulses that generate upwards and downward currents or pulses of water or other media. Such inflow and outflow of water to the unit generates a rising current of water 130 that improves the separation efficiency and a downward flow of water allows for the heavier particles to stratify.

The heavier materials that sink are discharged through a material discharge device such as a valve, gate, rotary valve, sealed bucket conveyor or sealed screw conveyor to allow for the heavier materials to exit the unit while reducing the amount of water or media that flows therethrough. The additional water or media that is required to make up for the lost water or media that abandons the unit through the lighter material discharge, fine heavier material discharge or the heavy material discharge zones may be added through the pulse chamber. The separated products produced in the density separation apparatus may be designated as follow: (1) the “lights”, which are discharge through an exit passage located on the top of the top of each unit; (2) the “fine heavies” or “hutch product”, which consists of fine particles that have a specific gravity large enough that they sink to the bottom of the unit; and (3) the “heavies”, which consists of the heavies that sank to the bottom of the unit. The heavies can be collected by one or more conveyors or drag conveyors.

In an alternate embodiment, the axial or tangential pipe or chamber 150 may generate a constant inflow of water or media rather than constant pulsating streams of water. Such continuous upflow of water will still generate a dimension of separation to enhance the efficiency of the separation and may be used when processing different materials. For example, the pulsating upward and downward motion may be used when processing prone to entanglement recyclables such as recyclables containing insulated or bare wire. The inflow and outflow of water will reduce the chances for light recyclables from ending on the heavy fraction.

In another embodiment, the media or fluid used in the recovery system may be any liquid capable of washing the materials and causing the metal to suspend into the process fluid. In other embodiments, the recovery system may use chemicals which can extract and suspend the desired constitute. Examples of such solutions are well known to those of skill in the art. One example of such a solution is water. In other embodiments, chemicals, minerals and or any magnetic material that can be used to change the specific gravity of the fluid to obtain an actual constant specific gravity range of 1.0 to 3.0 SG depending on the application.

In another embodiment, in some cases the media or fluid includes inorganic dirt, sand, glass fines, ferrous fines and combinations thereof. In such cases, the apparatus can use inorganic media fines that can come from automobile shredder residue fines, shredder fines from Hammermill operations, ferrous slag or inorganic fine byproducts from incineration and/or pyrolysis operations. Further, other minerals that may be mixed in a landfill containing metals can be recovered.

By using media with a specific gravity of 1.5 SG or higher, the costs to an operator can be reduced or nullified, that is, the costs to the operator may be net zero. Media with a specific gravity of 1.5 SG or higher can be separated into organics and inorganics.

The apparatus can have sensors connected to computers that incorporate algorithms to maximize efficiencies of the separation. The computer algorithms can optimize variables (e.g, paddlewheel 115, 215 speed) to obtain a desired separation.

The vertical motions of the density separator enhances the separation efficiency of the materials by processing high throughputs and reducing the limitations of typical recyclable materials such as moisture content and the necessity of a discrete size range. The density separator may provide a cost-effective method of concentrating recyclable materials into discrete specific gravities doing so at higher throughputs than typical sorting technologies. Such discrete specific densities are determined by the frequency, amplitude, or speed of the water or media generated by the paddlewheel 1 15, 215 as well as by the inflow and outflow of water through the bottom pipe or pulse chamber.

### EXAMPLES

FIGS. 1-2 and 4-6 show an exemplary apparatus or system employing the density separation process having multiple units in a linear arrangement 100, 200. In this arrangement, the apparatus or system provides more control over the agitation and forces separating the material. More specifically, in this arrangement, the slurry or waste stream 180 is fed into the unit 101, 201, and from the unit, the slurry or waste stream 180 flows to the second unit 102, 202 and so forth. The paddlewheel 115, 215 in some or all of the units creates movement to optimize the residence time (faster or slower) to optimize separation. Further, sensors, whether in the units or outside thereof, can be operatively linked to the paddlewheels to maintain a desired state within the units. Each of the units may have its own motor and driver. A constant flow of water or media 130, or a pulsating flow of water or media 130, is provided through an inlet pipe or chamber 150 connected to the bottom of one of the units. Again, the “heavies” discharge through a chute through a drag chain conveyor. The lights discharge passage can be provided with a de-watering screen or similar de-watering device such as a de-watering conveyor, screw conveyor or bucket elevator.

In one example, a first unit 101, 201 could be used to separate absorbent organics such foam, cloth or other absorbent materials that may absorb media (e.g, magnetite, sand). In another example, the first unit 101, 201 has a 1.0 SG (e.g., to separate organics), a second unit 102, 202 has a 1.2 sg (to separate valuable plastics, such as polystyrene or non-filled plastics), and a third unit 103, 203 has a 1.6 sg (organics vs. inorganics). Metal and minerals can be recovered from the third unit 103, 203.

What is claimed is:

1. An apparatus for separating materials of differing densities from a waste stream, the apparatus comprising:
a. a housing defining at least one separation unit having an inlet at an upper portion of the separation unit and an outlet at a lower portion of the separation unit;
b. a fluid medium contained within the separation unit to create a slurry with the waste stream;
c. at least one agitator disposed proximate a top region of the separation unit, the agitator configured to impart an upward and downward motion within the fluid medium; and
d. at least one stratification component in communication with the separation unit via an axial or tangential connection at or near a bottom region of the separation unit, the stratification component being configured to introduce a flow of the fluid medium into and out of the separation unit in a manner that establishes a vertical motion within the fluid medium,
wherein the upward and downward motion caused by both the agitator and the stratification component promotes separation of heavier materials from lighter materials.

2. The apparatus of claim 1, wherein the stratification component comprises a pulsating chamber that alternately discharges and retracts the fluid medium, creating a cyclical upward and downward flow of the fluid medium through the separation unit.

3. The apparatus of claim 1, wherein the agitator comprises a paddlewheel including a rotatable shaft extending vertically downward from a top portion of the separation unit, the shaft having a plurality of fixed paddles that, upon rotation, generate shear forces and upward currents within the fluid medium.

4. The apparatus of claim 1, further comprising a plurality of interconnected separation units disposed in a linear arrangement, each separation unit having an inlet, an outlet, and an agitator, wherein the waste stream passes sequentially from a first separation unit to subsequent separation units, and each separation unit is configured to separate materials based on a different specific gravity threshold of the fluid medium.

5. The apparatus of claim 1, further comprising a discharge device at the lower portion of the separation unit, the discharge device being selected from the group consisting of a movable gate, a rotary valve, a sealed bucket conveyor, and a sealed screw conveyor, the discharge device permitting heavier materials to exit the separation unit while minimizing fluid loss.

6. A method for separating materials of differing densities from a waste stream, the method comprising:
a. introducing the waste stream into a separation unit filled with a fluid medium;
b. imparting agitation to the fluid medium at an upper portion of the separation unit using a rotatable paddlewheel or similar agitator to generate shear forces and an upward current;
c. simultaneously introducing a flow of the fluid medium into or out of the separation unit through an axial or tangential connection at a lower portion of the separation unit to create a vertical motion;
d. allowing heavier materials in the waste stream to sink toward a bottom region of the separation unit for collection; and
e. allowing lighter materials to remain at or near a top surface of the fluid medium for discharge from the separation unit.

7. The method of claim 6, wherein the waste stream comprises automobile shredder residue (ASR), and further comprising adjusting the specific gravity of the processing media in at least one of the separation units to promote separation of non-metal fractions (e.g., rubber, plastics, foam) from metallic components.

8. The method of claim 6, further comprising adjusting one or more operating parameters selected from the group consisting of: rotational speed of the agitator; frequency and amplitude of fluid pulsation through the axial or tangential connection; and volume flow rate of the fluid medium, so as to control the residence time of particles within the separation unit and optimize the separation efficiency.

9. The method of claim 6, further comprising monitoring conditions within the separation unit using one or more sensors, and automatically modifying at least one of the agitator speed, frequency of pulsation, or fluid flow rate based on sensor feedback in order to maintain a desired separation state.

10. The method of claim 6, wherein the fluid medium is selected from the group consisting of: water; water mixed with chemicals or minerals to alter the fluid's specific gravity; inorganic fines including dirt, sand, glass fines, ferrous fines, or combinations thereof, such that the fluid medium can be maintained at a predetermined specific gravity within the range of about 1.0 to about 3.0 to enhance density-based separation.

11. A multi-stage density separation system for recovering heavier materials and lighter materials from a waste stream, the system comprising:
a. a first separator unit configured with a first fluid medium specific gravity for separating a first subset of lighter materials;
b. a second separator unit in fluid communication with the first separator unit and configured with a second fluid medium specific gravity for further separating a second subset of lighter materials and heavier materials;
c. at least one paddlewheel agitator in each separator unit, each paddlewheel agitator generating shear forces and an upward current in its respective separator unit;
d. at least one pulsation chamber or continuous flow device coupled to each separator unit to impart a vertical fluid flow;
e. a discharge zone for removing heavier materials from each separator unit; and
f. a controller operably connected to each separator unit and configured to adjust agitator speed and fluid flow parameters for each separator unit,
wherein the combination of upward current, vertical pulsations, and sequential specific gravity separations provides enhanced stratification and recovery of heavier materials from the waste stream.

12. The system of claim 11, wherein each of the two or more sorting units has a different predetermined specific gravity of processing media to sequentially separate the waste stream into discrete fractions.

13. The system of claim 11, wherein the discharge device comprises a rotary valve, a movable gate, a sealed screw conveyor, or a sealed bucket conveyor configured to reduce fluid loss during the discharge of heavier materials.

14. The system of claim 11, wherein the aeration chamber includes a pulsation mechanism that cyclically introduces air into the processing media, creating the upward and downward vertical motion of the processing media to enhance separation of entangled or agglomerated waste fractions.

15. The system of claim 11, wherein at least one of the two or more sorting units is configured to operate with continuous upward flow of the processing media rather than a pulsating flow, thereby providing adjustable separation conditions based on the nature of the waste stream being processed.

16. The system of claim 11, wherein the axial connection is configured to supply additional processing media to compensate for media losses and to maintain a substantially constant fluid level in the two or more sorting units.

17. The system of claim 11, wherein each processing container has a rectangular or conical shape, and the system is arranged such that a lighter material exit passage is located at an upper portion of each processing container, while a heavier material exit passage is located at or near a lower portion of each processing container.

18. A system for separating materials in a waste stream, comprising:
a. a feeder configured to receive the waste stream, the waste stream comprising incinerator ash, automobile shredder residue, whitegood shredder residue, e-waste, waste-to-energy slag, steelmaking slag, ferrochrome slag, retrieved landfill material, or a combination thereof,
b. two or more sorting units arranged in a linear configuration and in fluid connection with one another, each sorting unit comprising: a processing container having an inlet and an outlet, a processing media including water disposed within the processing container, the processing media having a specific gravity, wherein the specific gravity in at least two of the sorting units is different, and a mixer or paddlewheel configured to rotate and agitate the processing media within the sorting unit, the mixer or paddlewheel having a shaft extending from a center-top portion of the processing container;
c. an axial connection configured to introduce media into each sorting unit and generate an upward and downward vertical motion of the processing media;
d. a discharge device configured to allow discharge of separated heavier materials from at least one of the sorting units; and
e. an aeration chamber at or near the bottom of the sorting units, configured to alternately create upward and downward vertical motion of the processing media within each of the two or more sorting units, wherein the feeder is configured to introduce the waste stream into the inlet of a first sorting unit, the agitation and vertical motion of the processing media are configured to separate the waste stream into at least a light portion and a heavy portion in each sorting unit, the discharge device of the first sorting unit is configured to receive and discharge the heavy portion from the processing container of the first sorting unit, the outlet of the first sorting unit is configured to receive the light portion from the processing container of the first sorting unit, and the processing media comprises water.

19. A method of separating materials of differing densities from a waste stream using a multi-stage linear separation system, the method comprising:
a. introducing a waste stream into a first separation unit that contains a processing media with a first specific gravity;
b. rotating a paddlewheel or mixer at an upper portion of the first separation unit to agitate the processing media and create shear forces and upward currents;
c. pulsating the processing media via a pulse chamber at or near the bottom of the first separation unit to generate additional upward and downward flows;
d. discharging heavier materials that sink toward the bottom of the first separation unit through a discharge device while minimizing fluid loss;
e. transferring lighter materials from the first separation unit to a second separation unit that contains the processing media with a second specific gravity; and
f. adjusting at least one operational parameter in the second separation unit selected from paddlewheel speed, pulsation frequency, or processing media flow rate,
wherein sequential treatment in the first and second separation units provides enhanced density-based separation of lighter and heavier materials.

20. The method of claim 19, further comprising monitoring the torque or power draw of each paddlewheel or mixer in real time, and adjusting the rotational speed of the paddlewheel or mixer based on the monitored torque or power draw to maintain an optimal shear force for separating lighter and heavier materials.
